(19) United States
(12) Patent Application Publication
(10) Pub. No.: US 2011/0287312 A1
(43) Pub. Date: Nov. 24, 2011

(54) BIOFUEL CELL

(75) Inventors: Hideyuki Kumita, Kanagawa (JP); Taiki Sugiyama, Kanagawa (JP); Daisuke Yamaguchi, Kanagawa (JP); Tsunetoshi Samukawa, Kanagawa (JP); Hiroki Mita, Kanagawa (JP)

(73) Assignee: SONY CORPORATION, Tokyo (JP)

(21) Appl. No.: 13/089,561

(22) Filed: Apr. 19, 2011

(30) Foreign Application Priority Data
May 20, 2010 (JP) 2010-116287

(51) Int. Cl. H01M 2/08; H01M 4/64; H01M 2/02

(52) U.S. Cl. 429/185; 429/163

(57) ABSTRACT

Provided is a biofuel cell including: electrodes disposed inside a cell casing; and current collectors exposed to the outside of the cell casing; wherein a part of each of the current collectors is separably put in close contact with the corresponding electrode through an opening provided in the cell casing, in the state of being provided with a leakage preventive section configured to prevent a solution inside the cell casing from leaking out through the opening.

### BACKGROUND

The present technology relates to a biofuel cell. More particularly, the present technology relates to a biofuel cell in which current collectors can be easily separated from a cell structure.

In recent years, “biofuel cells” in which an oxidoreductase is immobilized as catalyst on at least one of an anode and a cathode have been developed. In the biofuel cells, a high cell capacity can be obtained by efficiently taking out electrons from a fuel which is difficult to bring into reaction by ordinary industrial catalysts, such as glucose and ethanol. In view of this advantage, the biofuel cells are expected as next-generation fuel cells high in both capacity and safety.

For example, in a biofuel cell using glucose as fuel, as shown in FIG. 6, an oxidation reaction of glucose proceeds at an anode, whereas a reduction reaction of oxygen proceeds at a cathode. At present, biofuel cells in which various fuels can be used, instead of being restricted to the use of glucose in combination with oxygen, have been being developed.

In primary cells (dry batteries) and secondary cells (storage batteries) according to related art, a hazardous substance such as heavy metal, etc. or an environmentally polluting substance such as strong alkali, strong acid, etc. or the like is contained in electrode active materials, an electrolyte solution, a fuel or the like. Therefore, these cells and batteries are recovered after being classified and separated from other wastes, before being disposed of.

In fuel cells using natural gas, hydrogen, methanol or the like as fuel, attempts to restrain environmental destruction from being caused by the fuel cells discarded after use thereof have been made by using a biodegradable material for one or some of the cell components. For instance, Japanese Patent Laid-open No. 2002-289211 (hereinafter referred to as Patent Document 1) discloses a power source system wherein a fuel enclosing section for enclosing a fuel for power generation therein is formed by use of a biodegradable plastic (see claim 6 in the document). In addition, Japanese Patent Laid-open No. 2007-128803 (hereinafter referred to as Patent Document 2) discloses a fuel cell wherein a biodegradable plastic is used for a separator (see claim 5 in the document).

### SUMMARY

As disclosed in the above-mentioned Patent Documents 1 and 2, in fuel cells using natural gas or the like as fuel, attempts to reduce environmental burden by rendering one or some of cell components biodegradable have been made. However, ordinary fuel cells contain a strong acid such as sulfuric acid in an electrolyte solution, and contain a rare element such as platinum in an electrode catalyst. In disposing of such fuel cells, therefore, it may be necessary, even if one or some of the cell components are biodegradable, to classify and separate the cells from other wastes and then to perform disassembly of the cells, separation of cell members, and so on.

On the other hand, biofuel cells do not contain any hazardous substance, environmentally polluting substance or the like in an enzyme (used as an electrode catalyst), an electron transport material, an immobilization film, an electrolyte solution, a fuel or the like. After only some metallic members are removed from cell structures of biofuel cells, therefore, the remaining portions of the biofuel cells may possibly be disposed of in the same manner as ordinary wastes.

Thus, it is desirable to provide a biofuel cell in which current collectors, present as metallic members, can be easily separated from a cell structure.

According to an embodiment of the present technology, there is provided a biofuel cell including: electrodes disposed inside a cell casing; and current collectors exposed to the outside of the cell casing, wherein a part of each of the current collectors is separably put in close contact with the corresponding electrode through an opening provided in the cell casing, in the state of being provided with a leakage preventive section configured to prevent a solution inside the cell casing from leaking out through the opening. In this biofuel cell, preferably, the electrodes are each formed from a carbon material, and the cell casing is formed from a biodegradable plastic.

From the viewpoint of cell performance, the current collectors are each preferably a metallic member, which is difficult to replace by a non-metallic member. In the biofuel cell according to the embodiment of the present technology, each of the current collectors exposed to the outside of the cell casing is separably put in close contact with the electrode disposed inside the cell casing, whereby the current collectors can be easily removed from the cell structure.

In the biofuel cell according to the embodiment of the present technology, the leakage preventive section may be realized in the form of peelable adhesion of the electrode and the current collector to each other with a conductive adhesive, or in the form of fixation of the current collector to the cell casing in a condition where the current collector is kept in close contact with the electrode by a re-sealable seal. Such a leakage preventive section makes it possible to prevent a solution inside the cell casing from leaking out through the opening at which the current collector and the electrode make contact with each other.

Besides, in the biofuel cell according to the embodiment of the present technology, preferably, water repellency is imparted to the portion of contact between the electrode and the current collector, or that portion of the electrode which makes contact with the current collector is formed from a low-permeability material. This makes it possible to prevent the solution inside the cell casing from leaking out through the openings, after separation of the current collectors from the electrodes.

Thus, according to an embodiment of the present technology, it is possible to provide a biofuel cell in which current collectors, present as metallic members, can be easily separated from a cell structure.

### BRIEF DESCRIPTION OF THE DRAWINGS

FIG. 1 is a schematic top plan view showing an external appearance of a biofuel cell according to a first embodiment of the present technology;

FIG. 2 is a schematic sectional view of the biofuel cell according to the first embodiment;

FIG. 3 is a schematic top plan view showing an external appearance of a biofuel cell according to a second embodiment of the present technology;

FIG. 4 is a schematic sectional view of the biofuel cell according to the second embodiment;

FIG. 5 is a schematic sectional view of a biofuel cell according to a third embodiment of the present technology; and

FIG. 6 illustrates oxidation-reduction reactions at electrodes in a biofuel cell in which glucose is used as fuel.

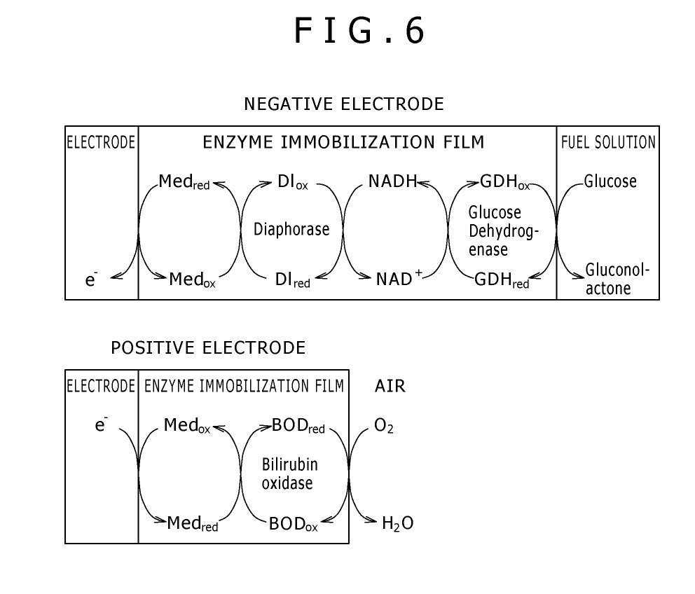

### DETAILED DESCRIPTION OF THE PREFERRED EMBODIMENTS

Now, some preferred embodiments of the present technology will be described below. Incidentally, the following embodiments are merely examples of representative embodiments of the present technology, and thus the scope of the present technology is not to be construed narrowly. The description will be made in the following order.

### 1. First Embodiment

### [Cell Structure]

### [Conductive Adhesive]

### [Electrode Material]

### [Current Collector Material]

### [Anode Enzymes]

### [Cathode Enzymes]

### [Separator Material]

### [Protonic Conductor]

### [Fuel]

### [Cell Casing Material]

### 2. Second Embodiment

### [Cell Structure]

### [Electrode Material]

### 3. Third Embodiment

### [Cell Structure]

### [Conductive Adhesive]

### [Electrode Material]

### 1. First Embodiment

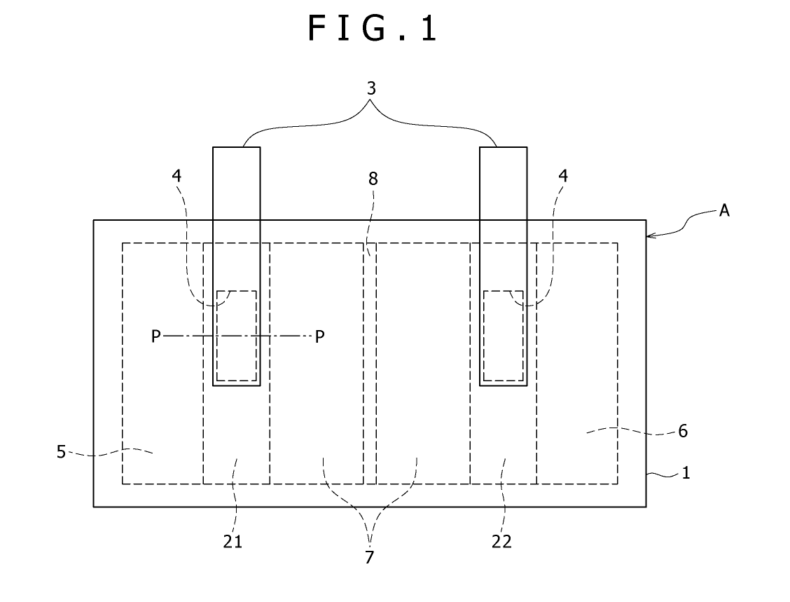

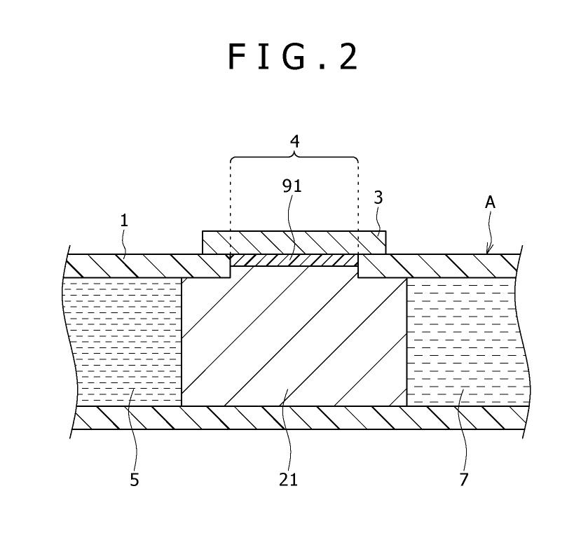

FIG. 1 is a schematic top plan view showing an external appearance of a biofuel cell according to a first embodiment of the present technology. FIG. 2 is a schematic sectional view of the biofuel cell according to the first embodiment, corresponding to a section taken along line P-P of FIG. 1.

### [Cell Structure]

The biofuel cell denoted by reference symbol A in the figure includes a cell casing 1, a pair of electrodes disposed inside the cell casing 1, and current collectors 3, 3 exposed to the outside of the cell casing 1. The electrodes include an anode (fuel electrode) 21 for taking out electrons produced by an oxidation reaction of a fuel 5, and a cathode (air electrode) 22 for performing a reduction reaction of oxygen supplied externally.

The cell casing 1 is filled, on the anode 21 side, with the fuel 5 being in contact with the electrode. Besides, to the cathode 22 side in the inside of the cell casing 1, air 6 is introduced in such a manner as to make contact with the electrode. The anode 21 and the cathode 22 are disposed with a shortcircuit-preventive diaphragm (hereinafter referred to as “separator”) 8 therebetween. In addition, the space between the anode 21 and the cathode 22 is filled with a protonic conductor (here, “electrolyte solution”) 7 being in contact with the electrodes.

On the anode 21 is present an enzyme for catalyzing an oxidation reaction of the fuel 5 and for taking out electrons. Besides, on the cathode 22 is present an enzyme by which a reduction reaction of oxygen is catalyzed. Current collectors 3, 3 are put in close contact with, and electrically connected to, the anode 21 and the cathode 22, respectively, through openings 4, 4 provided in the cell casing 1. To the current collectors 3, 3 is connected an external circuit (not shown) through which the electrons taken out at the anode 21 are sent to the cathode 22.

The current collector 3 and the corresponding electrode (the anode 21 or the cathode 22) are adhered to each other by a conductive adhesive layer 91 at the opening 4. This ensures that, in the biofuel cell A, the current collector 3 and the corresponding electrode are electrically connected to each other in the condition in which the solutions such as the fuel 5 and the electrolyte solution 7 inside the cell casing 1 are prevented from leaking out through the opening 4. Incidentally, if the fuel or the electrolyte solution leaks out of the cell, the aesthetic appearance or the feeling of use of the cell is damaged, and the cell becomes unfavorable from the viewpoint of hygiene and safety.

The adhesion between the current collector 3 and the electrode by the conductive adhesive layer 9 is made with such a bond strength that the current collector 3 and the electrode can be peeled from each other by an external force. This ensures that, in the biofuel cell A, the current collector 3 can be peeled from the electrode by an external force, to be easily separated from the cell structure.

The portion of contact between the current collector 3 and the electrode (that surface of the electrode which makes contact with the conductive adhesive layer 91) is preferably provided with water repellency by a water repellency imparting treatment. This ensures that the solution such as the fuel 5, the electrolyte solution 7, etc. having permeated the electrode would not oozes out through the opening 4, so that the solution inside the cell casing can be prevented from leaking out through the opening 4 after separation of the current collector 3 and the electrode from each other.

### [Conductive Adhesive]

The conductive adhesive layer 91 can be formed from an adhesive containing a conductive material such as silver powder, copper powder, carbon fibers, etc. dispersed in an epoxy resin, an acrylic resin, a silicone resin or the like. It is preferable to adopt a design such that the conductive adhesive layer 91 is left on the current collector 3 side after the separation of the current collector 3 and the electrode from each other. Such a design ensures that, even where the adhesive contains metallic particles as conductive material, the metallic particles can be separated and removed from the cell structure together with the current collector 3.

### [Electrode Material]

The material for forming the anode 21 and the cathode 22 is a carbon material such as porous carbon, carbon pellet, carbon paper, carbon felt, carbon fibers or carbon particulates in laminate form. The material for the anode 21 and the cathode 22 is preferably a porous carbon material. The anode 21 and the cathode 22 may be provided with a low-permeability material layer which will be described in a second embodiment later.

### [Current Collector Material]

The current collector 3 is preferably a metallic member, from the viewpoint of cell performance. Examples of the metallic material which can be used for the current collector include metals such as Pt, Ag, Au, Ru, Rh, Os, Nb, Mo, In, Ir, Zn, Mn, Fe, Co, Ti, V, Cr, Pd, Re, Ta, W, Zr, Ge, Hf, etc., alloys such as alumel, brass, duralumin, bronze, Nickelin, platinum-rhodium alloy, Hiperco, permalloy, Permendur, German silver, phosphor bronze, etc., borides such as HfB₂, NbB, CrB₂, etc., nitrides such as TiN, ZrN, etc., silicides such as VSi₂, NbSi₂, MoSi₂, TaSi₂, etc., and composite materials of them.

### [Anode Enzymes]

On the anode 21 is present an enzyme for catalyzing the oxidation reaction of the fuel 5 and for taking out electrons.

Examples of the enzyme here include glucose dehydrogenase, gluconate 5-dehydrogenase, gluconate 2-dehydrogenase, alcohol dehydrogenase, aldehyde reductase, aldehyde dehydrogenase, lactate dehydrogenase, hydroxypyruvate reductase, glycerate dehydrogenase, formate dehydrogenase, fructose dehydrogenase, galactose dehydrogenase, malate dehydrogenase, glyceraldehydes-3-phosphate dehydrogenase, lactate dehydrogenase, sucrose dehydrogenase, fructose dehydrogenase, sorbose dehydrogenase, pyruvate dehydrogenase, isocitrate dehydrogenase, 2-oxoglutarate dehydrogenase, succinate dehydrogenase, malate dehydrogenase, acyl-CoA dehydrogenase, L-3-hydroxyacyl-CoA dehydrogenase, 3-hydroxypropionate dehydrogenase, and 3-hydroxybutyrate dehydrogenase.

In addition, an oxidized coenzyme and a coenzyme oxidase may be immobilized on the anode 21. Examples of the oxidized coenzyme include nicotinamideadenine dinucleotide (hereinafter expressed as “NAD+”), nicotinamideadenine dinucleotide phosphate (hereinafter expressed as “NADP+”), flavin adenine dinucleotide (hereinafter expressed as “FAD+”), and pyrrolo-quinoline quinone (hereinafter expressed as “PQQ2+”). Examples of the coenzyme oxidase include diaphorase.

Further, an electron transport mediator may be immobilized on the anode 21. This is for ensuring smoother transfer of the generated electrons to the electrode. As the electron transport mediator, various materials can be used. Preferably, a compound having a quinone skeleton or a compound having a ferrocene skeleton is used as the electron transport mediator. Of the compounds having the quinone skeleton, particularly preferred are compounds having a naphthoquinone skeleton or an anthraquinone skeleton. Furthermore, if necessary, together with the compound having the quinone skeleton or the compound having the ferrocene skeleton, one or more other compounds which function as electron transport mediator may be immobilized on the anode 21.

Specific examples of the usable compounds having the naphthoquinone skeleton include 2-amino-1,4-naphthoquinone (ANQ), 2-amino-3-methyl-1,4-naphthoquinone (AMNQ), 2-amino-3-carboxy-1,4-naphthoquinone (ACNQ), 2,3-diamino-1,4-naphthoquinone, 4-amino-1,2-naphthoquinone, 2-hydroxy-1,4-naphthoquinone, 2-methyl-3-hydroxy-1,4-naphthoquinone, vitamin K₁ (2-methyl-3-phytyl-1,4-naphthoquinone), vitamin K₂ (2-farnesyl-3-methyl-1,4-naphthoquinone), and vitamin K₃ (2-methyl-1,4-naphthoquinone). In addition, as the compound having the quinone skeleton, for example, compounds having an anthraquinone skeleton such as anthraquinone-1-sulfonate, anthraquinone-2-sulfonate, etc. and their derivatives can also be used. As the compound having the ferrocene skeleton, for example, vinylferrocene, dimethylaminomethylferrocene, 1,1′-bis(diphenylphosphino)ferrocene, dimethylferrocene, ferrocenemonocarboxylic acid, and the like can be used. Further, other compounds which can be used include metal complexes of iron (Fe), or the like; compounds having a nicotinamide structure; compounds having a riboflavin structure; and compounds having a nucleotide phosphate structure. More specific examples include methylene blue, pycocyanine, indigo-tetrasulfonate, luciferin, gallocyanine, pyocyanine, methyl apri blue, resorufin, indigo-trisulfonate, 6,8,9-trimethyl-isoalloxazine, chloraphine, indigo disulfonate, nile blue, indigocarmine, 9-phenyl-isoalloxazine, thioglycolic acid, 2-amino-N-methyl phenazinemethosulfate, azure A, indigo-monosulfonate, anthraquinone-1,5-disulfonate, alloxazine, brilliant alizarin blue, crystal violet, patent blue, 9-methyl-isoalloxazine, cibachron blue, phenol red, anthraquinone-2,6-disulfonate, neutral blue, bromphenol blue, anthraquinone-2,7-disulfonate, quinoline yellow, riboflavin, flavin mononucleotide (FMN), flavin adenine dinucleotide (FAD), phenosafranin, lipoamide, safranine T, lipoic acid, indulin scarlet, 4-aminoacridine, acridine, nicotinamideadenine dinucleotide (NAD), nicotinamide adenine dinucleotide phosphate (NADP), neutral red, cysteine, benzyl viologen(2+/1+), 3-aminoacridine, 1-aminoacridine, methyl viologen(2+/1+), 2-aminoacridine, 2,8-diaminoacridine, and 5-aminoacridine. In the above chemical formulas, dien stands for diethylenetriamine, and edta stands for ethylenediaminetetraacetate tetraanion.

### [Cathode Enzymes]

On the cathode 22 is present an enzyme which catalyzes a reduction reaction of oxygen supplied externally.

Examples of such an enzyme include those enzymes which have oxidase activity with oxygen as a reaction substrate, specific examples including laccase, bilirubin oxidase, ascorbate oxidase, CueO, and CotA.

In addition, an electron transport mediator may be immobilized on the cathode 22. This is for smoothening the acceptance of electrons sent from the anode. The electron transport mediator which can be immobilized on the cathode is required only to be higher in oxidation-reduction potential than the electron transport mediator used for the anode. Electron transport mediators which satisfy this condition can be freely selected for use, as required.

Specific examples of the electron transport mediator to be used here include ABTS (2,2′-azinobis(3-ethylbenzoline-6-sulfonate)), K₃[Fe(CN)₆], Cu^{III/II}(H₂A₃)^{0/1-}, [Fe(dpy)]^{3+/2+}, Cu^{III/II}(H₂G₃a)^{0/1-}, I₃⁻/I⁻, ferrocene carboxylic acid, [Fe(CN)₆]^{3-/4-}, ferrocene ethanol, Fe^{3+/2+} malonate, Fe^{3+/2+}, salycylate, [Fe(edta)]^{1-/2-}, [Fe(ox)₃]^{3-/4-}, promazine (n=1) [ammonium form], chloramine-T, TMPDA (N,N,N′,N′-tetramethylphenylenediamine), porphyrexide, syringaldazine, o-tolidine, bacteriochlorophyll a, dopamine, 2,5-dihydroxy-1,4-benzoquinone, p-aminodimethylaniline, o-quinone/1,2-hydroxybenzene (catechol), p-aminophenoltetrahydroxy-p-benzoquinone, 2,5-dichloro-p-benzoquinone, 1,4-benzoquinone, diaminodurene, 2,5-dihydroxyphenylacetic acid, 2,6,2′-trichloroindophenol, indophenol, o-toluidine blue, DCPIP (2,6-dichlorophenolindophenol), 2,6-dibromo-indophenol, phenol blue, 3-amino-thiazine, 1,2-naphthoquinone-4-sulfonate, 2,6-dimethyl-p-benzoquinone, 2,6-dibromo-2′-methoxy-indophenol, 2,3-dimethoxy-5-methyl-1,4-benzoquinone, 2,5-dimethyl-p-benzoquinone, 1,4-dihydroxy-naphthoic acid, 2,6-dimethyl-indophenol, 5-isopropyl-2-methyl-p-benzoquinone, 1,2-naphthoquinone, 1-naphthol-2-sulfonate indophenol, toluylene blue, TTQ (tryptophan tryptophylquinone), model (3-methyl-4-(3′-methylindol-2′-yl)indol-6,7-dione), ubiquinone (coenzyme Q), PMS (N-methylphenazinium methosulfate), TPQ (topa quinone or 6-hydroxydopa quinone), PQQ (pyrroloquinolinequinone), thionine, thionine-tetrasulfonate, ascorbic acid, PES (phenazine ethosulfate), cresyl blue, 1,4-naphthoquinone, toluidine blue, thiazine blue, gallocyanine, thioindigo disulfonate, methylene blue, and vitamin K₃ (2-methyl-1,4-naphthoquinone. In the above chemical formulas, dpy stands for 2,2′-dipyridine, phen stands for 1,10-phenanthroline, Tris stands for tris(hydroxymethyl)aminomethane, trpy stands for 2,2′:6′, 2″-terpyridine, Im stands for imidazole, py stands for pyridine, thmpy stands for 4-(tris(hydroxymethyl)methyl)pyridine, bhm stands for bis(bis(hydroxymethyl)methyl, G3a stands for triglycineamide, A3 stands for trialanine, ox stands for oxalate dianion, edta stands for ethylenediaminetetraacetate tetraanion, gly stands for glycinate anion, pdta stands for propylenediaminetetraacetate tetraanion, trdta stands for trimethylenediaminetetraacetate tetraanion, and cydta stands for 1,2-cyclohexanediaminetetraacetate tetraanion.

The manner in which the enzyme is present on the electrode is not limited to the manner in which the enzyme is immobilized on the electrode surface by the immobilization film. For instance, there may be adopted the manner in which microorganism which acts as a reaction catalyst for catalyzing an oxidation-reduction reaction is deposited on the electrode surface. The immobilization of the enzyme, the coenzyme and the electron transport mediator by the immobilization film can be carried out by a known technique. Particularly, the immobilization is preferably carried out by forming the immobilization film through the use of a bio-derived polymer such as polypeptide. Incidentally, the term “electrode surface” used here includes the outer surfaces of the electrode and, in the case where the electrode is formed from a porous material, also includes the surfaces of voids (pores) present in the inside of the electrode.

### [Separator Material]

The separator 8 is formed from a material which is permeable to the electrolyte solution 7 or a component thereof. For example, the separator 8 is formed from a cellulose-based non-woven fabric, cellophane or the like.

### [Protonic Conductor]

As the protonic conductor, an electrolyte which does not have electronic conductivity and which is capable of transporting H⁺ is used. As the protonic conductor, for example, an electrolyte solution containing a buffer substance may be used. As the electrolyte solution, particularly, a neutral buffer solution with a pH of around 7 is preferably used. Examples of the buffer substance which can be used here include dihydrogen phosphate ion (H₂PO₄⁻) produced by sodium dihydrogen phosphate (NaH₂PO₄) or potassium dihydrogen phosphate (KH₂PO₄) or the like, 2-amino-2-hydroxymethyl-1,3-propanediol (abbreviated to tris), 2-(N-morpholino)ethanesulfonic acid (MES), cacodylic acid, carbonic acid (H₂CO₃), hydrogen citrate ion, N-(2-acetamido)iminodiacetic acid (ADA), piperazine-N,N′-bis(2-ethanesulfonic acid) (PIPES), N-(2-acetamido)-2-aminoethanesulfonic acid (ACES), 3-(N-morpholino)propanesulfonic acid (MOPS), N-2-hydroxyethylpiperazine-N′-2-ethanesulfonic acid (HEPES), N-2-hydroxyethylpiperazine-N′-3-propanesulfonic acid (HEPPS), N-[tris(hydroxymethyl)methyl]glycine (abbreviated to tricine), glycylglycine, N,N-bis(2-hydroxyethyl)glycine (abbreviated to bicine), imidazole, triazole, pyridine derivatives, bipyridine derivatives, and compounds having an imidazole ring such as imidazole derivatives (histidine, 1-methylimidazole, 2-methylimidazole, 4-methylimidazole, 2-ethylimidazole, ethyl imidazole-2-carboxylate, imidazole-2-carboxyaldehyde, imidazole-4-carboxylic acid, imidazole-4,5-dicarboxylic acid, imidazol-1-yl-acetic acid, 2-acetylbenzimidazole, 1-acetylmidazole, N-acetylimidazole, 2-aminobenzimidazole, N-(3-aminopropyl)imidazole, 5-amino-2-(trifluoromethyl)benzimidazole, 4-azabenzimidazole, 4-aza-2-mercaptobenzimidazole, benzimidazole, 1-benzylimidazole, 1-butylimidazole). Also usable are Nafion (registered trademark), which is solid electrolyte, and the like.

### [Fuel]

The fuel 5 is a material which can be used as a fuel in the biofuel cell, and is preferably a liquid containing at least one substance which can serve as a substrate for the oxidase on the anode 21. Examples of the material which can be used as the fuel 5 include saccharides (sugars), alcohols, aldehydes, lipids and proteins. Specific examples include saccharides such as glucose, fructose, sorbose, etc., alcohols such as ethanol, glycerin, etc., and organic acids such as acetic acid, pyruvic acid, etc. Other examples than the just-mentioned include oils and fats, proteins, and organic acids as intermediate products of saccharometabolism of these substances.

### [Fuel Casing Material]

The fuel casing 1 is formed from a biodegradable plastic. Examples of the material which can be used as the biodegradable plastic include polymer materials containing a chemically synthesized type organic compound synthesized from a petroleum material, such as polylactic acid, aliphatic polyesters, copolymeric polyesters, etc.; bio-polyesters produced by microorganisms; and polymer materials based on utilization of natural matter such as chitosan, chitin, cellulose and starch extracted from vegetable materials such as corn, sugarcane, etc. A representative example of degradation process (decomposition reactions) of these biodegradable plastics is a process in which water and carbon dioxide are discharged through a series of activities such as hydrolysis, enzymolysis, absorption, etc. by microorganisms and/or enzymes present in soil.

In the biofuel cell A according to this embodiment, the current collector 3, which is a metallic member, is peelably adhered to the electrode by the conductive adhesive layer 91. A configuration is adopted in which the current collector 3 can be easily separated from the cell structure by peeling the current collector 3 from the electrode by an external force. This ensures that, at the time of disposing of the biofuel cell A after use thereof, the current collectors 3 as metallic members can be easily removed for separated disposal.

Besides, in the biofuel cell A, a carbon material is used as the electrode material, the cell casing 1 is formed from a biodegradable plastic, and, further, harmless natural matters or their derivatives are used for the enzymes, the immobilization films, the separator, the electrolyte solution, the fuel, etc. This ensures that after removal of the current collectors 3 from the biofuel cell A, the remaining portion of the biofuel cell A can be disposed of in the same manner as ordinary wastes.

Incidentally, the configuration according to this embodiment is applicable to both the case of “submerged system” where the fuel solution makes contact with both the anode 21 and the cathode 22 and the case of “exposed-to-air system” where only the anode makes contact with the fuel solution. In addition, the configuration according to this embodiment is applicable not only to a fuel cell of a “monocell” structure in which a single cell section is provided in the cell body but also to a cell of a structure in which a plurality of cell sections are connected in series or in parallel.

### 2. Second Embodiment

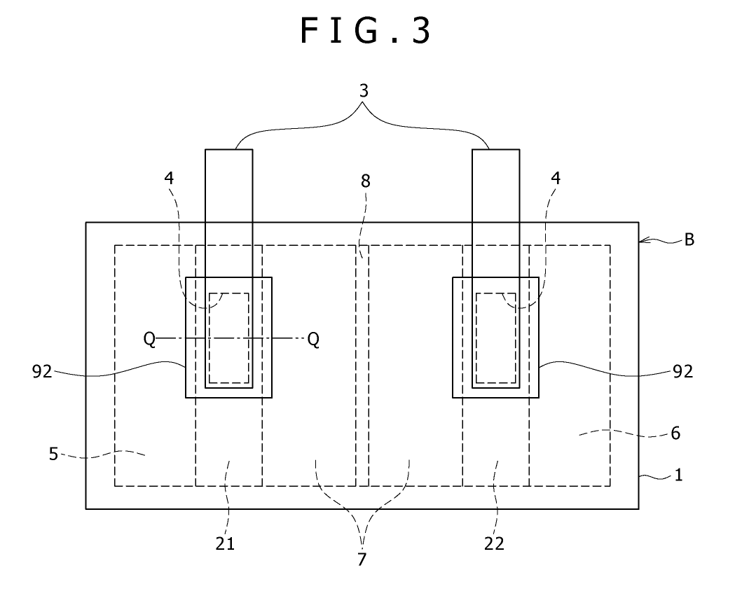

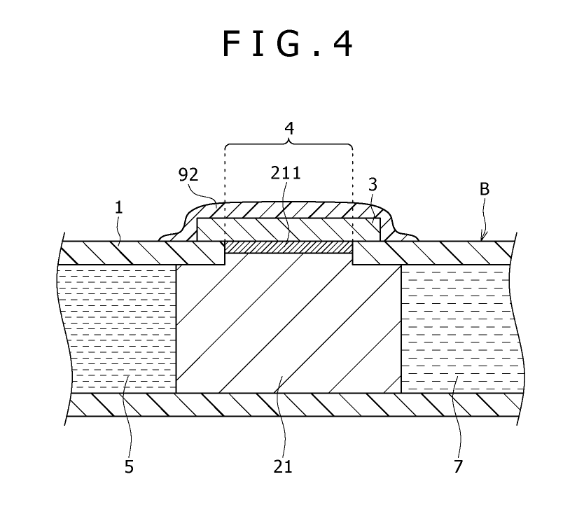

FIG. 3 is a schematic top plan view showing the external appearance of a biofuel cell according to a second embodiment of the present technology. FIG. 4 is a schematic sectional view of the biofuel cell according to the second embodiment, corresponding to a section taken along line Q-Q of FIG. 3.

### [Cell Structure]

The biofuel cell denoted by reference symbol B in the figure includes a cell casing 1, a pair of electrodes disposed inside the cell casing 1, and current collectors 3, 3 exposed to the outside of the cell casing 1. The electrodes include an anode (fuel electrode) 21 for taking out electrons produced by an oxidation reaction of a fuel 5, and a cathode (air electrode) 22 for performing a reduction reaction of oxygen supplied externally.

The cell casing 1 is filled, on the anode 21 side, with the fuel 5 being in contact with the electrode. Besides, to the cathode 22 side in the inside of the cell casing 1, air 6 is introduced so as to make contact with the electrode. The anode 21 and the cathode 22 are disposed with a shortcircuit-preventive diaphragm (hereinafter referred to as “separator”) 8 therebetween. In addition, the space between the anode 21 and the cathode 22 is filled with a protonic conductor (here, “electrolyte solution”) 7 being in contact with the electrodes.

On the anode 21 is present an enzyme for catalyzing an oxidation reaction of the fuel 5 and for taking out electrons. Besides, on the cathode 22 is present an enzyme by which a reduction reaction of oxygen is catalyzed. Current collectors 3, 3 are put in close contact with, and electrically connected to, the anode 21 and the cathode 22, respectively, through openings 4, 4 provided in the cell casing 1. To the current collectors 3, 3 is connected an external circuit (not shown) through which the electrons taken out at the anode 21 are sent to the cathode 22.

The current collector 3 is fixed to the cell casing 1 by a re-sealable seal 92 at the opening 4, and is pressed by the seal 92 into close contact with the electrode (the anode 21 or the cathode 22). This ensures that, in the biofuel cell B, the current collector 3 and the corresponding electrode are electrically connected in such a manner that the solutions such as the fuel 5 and the electrolyte solution 7 inside the cell casing 1 are prevented from leaking out through the opening 4.

In the biofuel cell B, it is possible by peeling the seals 92 to cancel the close contact state between the current collectors 3 and the electrodes, and thereby to easily separate the current collectors 3 from the cell structure. Further, when the seals 92 are re-sealed after separation of the current collectors 3 from the electrodes, the solutions inside the cell casing 1 can be prevented from leaking out through the openings 4.

### [Electrode Material]

The material for the anode 21 and the cathode 22 is a carbon material such as porous carbon, carbon pellet, carbon paper, carbon felt, carbon fibers or carbon particulates in laminate form. The material for the anode 21 and the cathode 22 is preferably a porous carbon material.

The portion of contact between the electrode and the current collector 3 is preferably a low-permeability material layer 211 formed from a material which is low in permeability. This ensures that the solutions such as the electrolyte solution 7 and the fuel 5 having permeated the electrodes would not exude through the openings 4, so that the solutions inside the cell casing can be prevented from leaking out through the openings 4 after separation of the current collectors 3 from the electrodes. For example, the low-permeability material layer 211 may be formed by use of a solid material or a high-carbon-density material selected particularly from among the above-mentioned carbon materials, whereas the remaining portion of the electrode may be formed by use of a fibrous material or a low-carbon-density material.

Furthermore, the portion of contact between the current collector 3 and the electrode (that surface of the low-permeability material layer 211 which makes contact with the current collector 3) may be provided with water repellency by a water repellency imparting treatment, as described in the first embodiment above.

In the biofuel cell B according to this embodiment, the current collectors 3 as metallic members are put in close contact with the electrodes by the re-sealable seals 92. Besides, a configuration is adopted in which the current collectors 3 can be easily separated from the cell structure by peeling off the seals 92. This ensures that, at the time of disposing the biofuel cell B after use thereof, the current collectors 3 as metallic members can be easily removed for separated disposal.

In addition, in the biofuel cell B, a carbon material is used as the electrode material, the cell casing 1 is formed from a biodegradable plastic, and, further, harmless natural matters or their derivatives are used for the enzymes, the immobilization films, the separator, the electrolyte solution, the fuel, etc. This ensures that after removal of the current collectors 3 from the biofuel cell B, the remaining portion of the biofuel cell B can be disposed of in the same manner as ordinary wastes.

In the biofuel cell B according to this embodiment, the current collector material, the anode and cathode enzymes, the separator material, the protonic conductor, the fuel, the cell casing material and the like may be the same as those in the biofuel cell A according to the first embodiment above.

Besides, the configuration according to this embodiment is applicable to both the case of “submerged system” where the fuel solution makes contact with both the anode 21 and the cathode 22 and the case of “exposed-to-air system” where only the anode makes contact with the fuel solution. In addition, the configuration according to this embodiment is applicable not only to a fuel cell of a “monocell” structure in which a single cell section is provided in the cell body but also to a cell of a structure in which a plurality of cell sections are connected in series or in parallel.

### 3. Third Embodiment

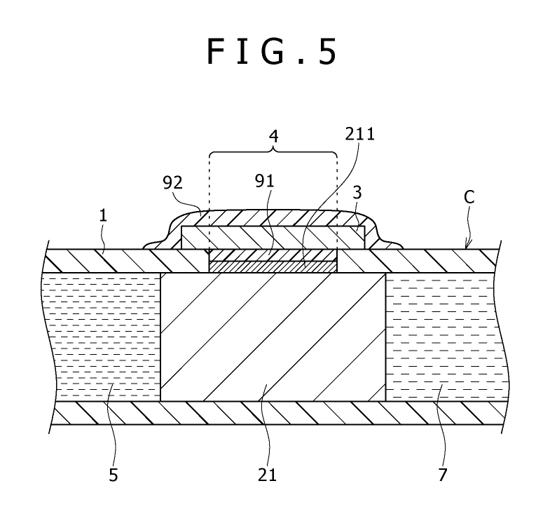

FIG. 5 is a schematic sectional view of a biofuel cell according to a third embodiment of the present technology.

### [Cell Structure]

The biofuel cell denoted by reference symbol C in the figure includes a cell casing 1, a pair of electrodes disposed inside the cell casing 1, and current collectors 3, 3 exposed to the outside of the cell casing 1. The electrodes include an anode (fuel electrode) 21 for taking out electrons by an oxidation reaction of a fuel 5, and a cathode (air electrode) 22 for performing a reduction reaction of oxygen supplied externally.

The cell casing 1 is filled, on the anode 21 side, with the fuel 5 being in contact with the electrode. Besides, to the cathode 22 side in the inside of the cell casing 1, air 6 is introduced so as to make contact with the electrode. The anode 21 and the cathode 22 are disposed with a shortcircuit-preventive diaphragm (hereinafter referred to as “separator”) 8 therebetween. In addition, the space between the anode 21 and the cathode 22 is filled with a protonic conductor (here, “electrolyte solution”) 7 being in contact with the electrodes.

On the anode 21 is present an enzyme for catalyzing an oxidation reaction of the fuel 5 and for taking out electrons. Besides, on the cathode 22 is present an enzyme for catalyzing a reduction reaction of oxygen. Current collectors 3, 3 are put in close contact with, and electrically connected to, the anode 21 and the cathode 22, respectively, through openings 4, 4 provided in the cell casing 1. To the current collectors 3, 3 is connected an external circuit (not shown) through which the electrons taken out at the anode 21 are sent to the cathode 22.

The current collector 3 and the electrode (the anode 21 or the cathode 22) are adhered to each other by a conductive adhesive layer 91 at the opening 4. This ensures that, in the biofuel cell C, the current collector 3 and the corresponding electrode are electrically connected to each other in such a manner that the solutions such as the fuel 5 and the electrolyte solution 7 inside the cell casing 1 is prevented from leaking out through the opening 4. Further, the current collector 3 is fixed to the cell casing 1 by a re-sealable seal 92, and is pressed into close contact with the electrode by the seal 92. Consequently, adhesion between the current collector 3 and the electrode is enhanced, and leakage of the solutions through the opening 4 is prevented more securely.

The adhesion between the current collector 3 and the electrode by the conductive adhesive layer 91 is made with such a bond strength that the current collector 3 and the electrode can be peeled from each other by an external force. This ensures that, in the biofuel cell C, the current collector 3 can be peeled from the electrode by an external force, to be easily separated from the cell structure. Further, when the seal 92 is re-sealed after separation between the current collector 3 and the electrode, the solutions inside the cell casing 1 is prevented from leaking out through the opening 4.

### [Conductive Adhesive]

The conductive adhesive layer 91 can be formed from an adhesive containing a conductive material such as silver powder, copper powder, carbon fiber, etc. dispersed in an epoxy resin, an acrylic resin, a silicone resin or the like. It is preferable to adopt a design such that the conductive adhesive layer 91 is left on the current collector 3 side after the separation of the current collector 3 and the electrode from each other. Such a design ensures that, even where the adhesive contains metallic particles as conductive material, the metallic particles can be separated and removed from the cell structure together with the current collector 3.

### [Electrode Material]

The material for forming the anode 21 and the cathode 22 is a carbon material such as porous carbon, carbon pellet, carbon paper, carbon felt, carbon fibers or carbon particulates in laminate form. The material for the anode 21 and the cathode 22 is preferably a porous carbon material.

That portion of the electrode which makes contact with the current collector 3 (that portion of the electrode which is connected to the current collector 3 through the conductive adhesive layer 91) is preferably a low-permeability material layer 211 formed by use of a material which is low in permeability. This ensures that the solutions such as the electrolyte solution 7 and the fuel 5 having permeated the electrode would not exude through the opening 4, so that the solutions inside the cell casing can be prevented from leaking out through the opening 4 after separation between the current collector 3 and the electrode. For example, the low-permeability material layer 211 may be formed by use of a solid material or a high-carbon-density material selected particularly from among the above-mentioned carbon materials, whereas the remaining portion of the electrode may be formed by use of a fibrous material or a low-carbon-density material.

Further, the portion of contact between the current collector 3 and the electrode (that surface of the permeability material layer 211 which makes contact with the conductive adhesive layer 91) is preferably provided with water repellency by a water repellency imparting treatment. This ensures that the solutions such as the electrolyte solution 7 and the fuel 5 having permeated the electrode would not exude through the opening 4, so that the solutions inside the cell casing can be prevented from leaking out through the opening 4 after separation between the current collector 3 and the electrode.

In the biofuel cell C according to this embodiment, the current collectors 3 as metallic members are peelably put in close contact with the electrodes by the conductive adhesive layer 91. Besides, a configuration is adopted in which the current collector 3 can be easily separate from the cell structure by peeling off the current collector 3 from the electrode by an external force. This ensures that, at the time of disposing of the biofuel cell C after use thereof, the current collectors 3 as metallic members can be easily removed for separated disposal.

In addition, in the biofuel cell C, a carbon material is used as the electrode material, the cell casing 1 is formed from a biodegradable plastic, and, further, harmless natural matters or their derivatives are used for the enzymes, the immobilization films, the separator, the electrolyte solution, the fuel, etc. This ensures that after removal of the current collectors 3 from the biofuel cell C, the remaining portion of the biofuel cell C can be disposed of in the same manner as ordinary wastes.

In the biofuel cell C according to this embodiment, the current collector material, the anode and cathode enzymes, the separator material, the protonic conductor, the fuel, the cell casing material and the like may be the same as those in the biofuel cell A according to the first embodiment above.

Besides, the configuration according to this embodiment is applicable to both the case of “submerged system” where the fuel solution makes contact with both the anode 21 and the cathode 22 and the case of “exposed-to-air system” where only the anode makes contact with the fuel solution. In addition, the configuration according to this embodiment is applicable not only to a fuel cell of a “monocell” structure in which a single cell section is provided in the cell body but also to a cell of a structure in which a plurality of cell sections are connected in series or in parallel.

The biofuel cells according to the embodiments of the present technology are each so configured that, at the time of disposing of the biofuel cell after use thereof, the current collectors as metallic members can be easily removed from the biofuel cell for separated disposal, and the remaining portion of the biofuel cell can be disposed of in the same manner as ordinary wastes. Therefore, the biofuel cells according to the embodiments of the present technology exert little burden on environments upon disposal thereof, and can be disposed of by the user himself or herself. Accordingly, the biofuel cells according to the embodiments of the present technology eliminate the need for separated collection of the cells after use thereof, disassembly of the collected cells, separation of members, or the like.

The present disclosure contains subject matter related to that disclosed in Japanese Priority Patent Application JP 2010-116287 filed in the Japan Patent Office on May 20, 2010, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A biofuel cell comprising:
electrodes disposed inside a cell casing; and
current collectors exposed to the outside of the cell casing;
wherein a part of each of the current collectors is separably put in close contact with the corresponding electrode through an opening provided in the cell casing, in the state of being provided with a leakage preventive section configured to prevent a solution inside the cell casing from leaking out through the opening.

2. The biofuel cell according to claim 1, wherein the leakage preventive section comprises peelable adhesion of the electrode and the current collector to each other with a conductive adhesive, or fixation of the current collector to the cell casing in a condition where the current collector is kept in close contact with the electrode by a re-sealable seal.

3. The biofuel cell according to claim 2, wherein water repellency is imparted to a portion of contact between the electrode and the current collector.

4. The biofuel cell according to claim 2, wherein that portion of the electrode which makes contact with the current collector is formed from a low-permeability material.

5. The biofuel cell according to claim 1, wherein the electrode is formed from a carbon material, and the cell casing is formed from a biodegradable plastic.
